(19) United States
(12) Patent Application Publication
(10) Pub. No.: US 2013/0293531 A1
(43) Pub. Date: Nov. 7, 2013

(54) USER PERCEPTION OF VISUAL EFFECTS

(71) Applicants: Xiang Cao, Beijing (CN); Haimo Zhang, Singapore (SG)

(72) Inventors: Xiang Cao, Beijing (CN); Haimo Zhang, Singapore (SG)

(73) Assignee: MICROSOFT CORPORATION, Redmond, WA (US)

(21) Appl. No.: 13/461,497

(22) Filed: May 1, 2012

(51) Int. Cl. G06T 15/00

(52) U.S. Cl. 345/419

(57) ABSTRACT

At least two images that differ in some respect may be presented to a user. In response to viewing the at least two images, the user may perceive a certain visual effect that may or may not be present if the user viewed the at least two images individually. As a result, by presenting a different image to each eye of the user, the user may perceive a unique, a different, and/or an enhanced visual experience.

### BACKGROUND

Given that humans have two eyes, a binocular vision system allows humans to see their respective surroundings in two different perspectives. That is, binocular viewing of the same scene creates two slightly different images of that scene in the two eyes due to the eyes' different positions on the head. These differences, which may be referred to as binocular disparity, may provide information that allows the brain to process the two different images in order to generate depth sensation, such as by calculating a depth of objects (e.g., people, houses, trees, etc.) included in the scene. As a result, although viewing slightly different scenes through each eye, humans are able to perceive a single scene as well as depth perception of that scene.

Attempts have been made to simulate the stereo viewing experience, as described above. For instance, existing techniques have attempted to reproduce human stereo vision on computer displays in order to generate a three-dimensional (3D) viewing experience for the user. More particularly, two offset images, such as prerecorded or synthesized stereo images, may be presented separately to each eye of the viewer in order to simulate 3D sensations. These two two-dimensional images may then be combined in the brain of the viewer to give the perception of 3D depth. For example, using these techniques, a viewer of a television program or a player of a video game may perceive that images situated on the two-dimensional display screen actually project outwards towards, or inwards away from, the user. However, existing computer stereoscopic display techniques have been limited to, and aimed at, generating a perceived 3D viewing experience that simulates a real-world stereo viewing experience for users.

### SUMMARY

Described herein are systems and/or processes for utilizing stereoscopic display techniques to create an enhanced visual experience for a user. More particularly, the systems and/or processes described herein may present a first image to one eye of a user and a second image to the other eye of the user, where the first image and the second image may differ in some respect. Upon viewing the first image and the second image, the user may perceive a particular visual effect that may or may not be present in the first image alone and/or the second image alone. For example, the user may perceive a highlighting visual effect, a compositing visual effect, a hiding visual effect, and/or a hyper-color visual effect, among others. As a result, the user may perceive a unique and/or enhanced visual experience other than, or in addition to, perceiving a three-dimensional visual effect.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example system including a user, a presentation device, a network, and a content server. In this system, a particular visual experience may be provided to the user based at least in part on the specific images presented to the user.

FIG. 2 is a diagram showing an example system for presenting an enhanced visual experience to a user utilizing one or more stereoscopic display techniques.

FIG. 3 is a diagram showing a system for presenting a pair of different images to a user in order to cause the user to perceive a certain visual effect.

FIG. 4 is a flow diagram showing an example process of causing a user to perceive a particular visual effect.

### DETAILED DESCRIPTION

Described herein are systems and/or processes for utilizing one or more techniques in order to provide an enhanced viewing experience to users. In various embodiments, two images (or videos), which are different from one another, may be presented to each eye of a user. In response, the two images presented to the user may cause the user to perceive a certain intended visual effect. In some embodiments, the user may provide various forms of feedback relating to what the user actually sees when the two images are being viewed by the user. Based at least in part on this feedback, at least one of the images may be modified, two different images may be selected, or the two images may be switched such that each eye is presented a different one of the two images. Then, additional feedback relating to user perception of the two images may be received from the user. Therefore, based at least in part on specific images that are presented to each eye of the user, the user may perceive a unique, different, and/or enhanced visual effect. This perceived visual effect may be different than what would be perceived if only one of the images was presented to the user.

In some embodiments, the pair of images (or videos) that is presented to each eye of the user may differ from each other in dimensions other than stereo disparity in order to create a unique visual experience for the viewer. For example, a particular region of an image may be highlighted and made more noticeable to the viewer by displaying different colors, for example, to the two eyes in that particular region. Moreover, a compositing technique may relate to presenting two images of the same scene, where the two images may be complementary or overlapping in terms of an information spectrum with respect to a certain dimension. In these embodiments, the human perception system may composite such information in order to receive a higher information bandwidth than is possible with viewing a single image. In additional embodiments, certain portions of an image may be hidden by presenting information that is visible when utilizing one eye to view the image, but is invisible or less noticeable when viewing the image(s) with both eyes.

Furthermore, by presenting different colors to each eye in various regions of an image, a “hyper-color” may be perceived by the viewer, in which the hyper-color corresponds to a color sensation that is not typically experienced by viewers. In additional embodiments, a binocular color space that defines the dimensions of such hyper-colors may be developed and utilized as a reference or palette for creating hyper-colors. A ghosting effect may also be produced by showing an image pair to the viewer, where an object is perceived in one eye but not the other, thus giving that object a ghost-like appearance. In some embodiments, the eye dominance of a particular user may be measured and taken into consideration when implementing the techniques described above and set forth below in additional detail.

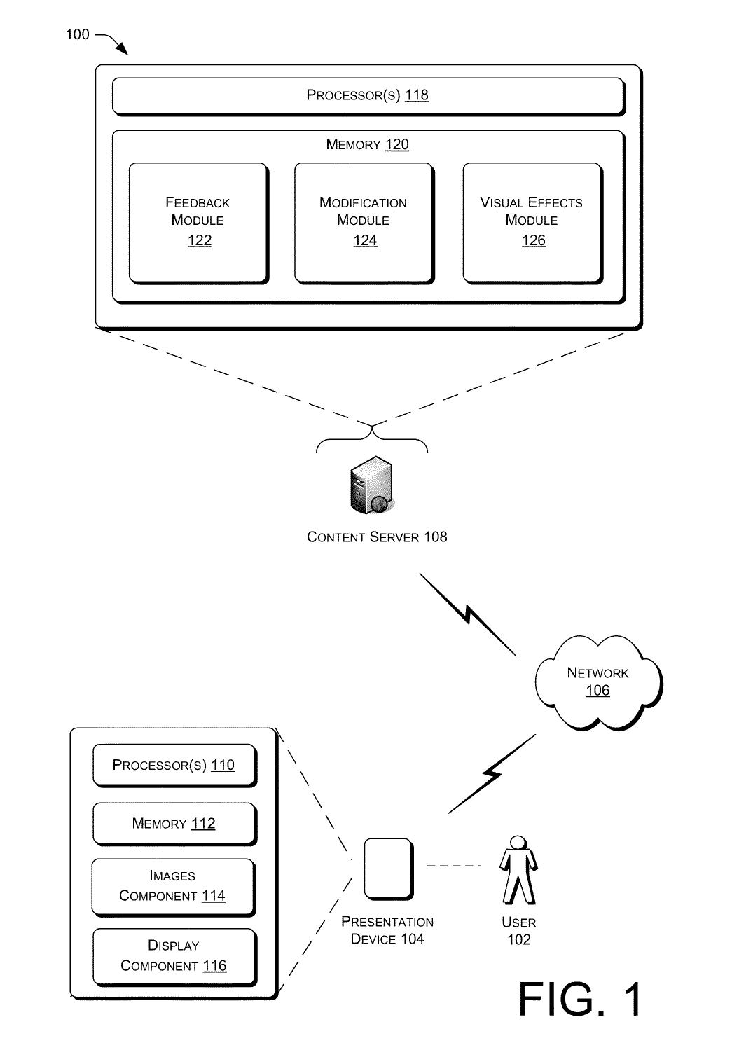

These visual experiences that may be generated for viewers may be implemented in the entertainment industry (e.g., gaming, movies, television programs, etc.) and/or other computer graphics applications. Various examples of presenting enhanced visual experiences to viewers, in accordance with the embodiments, are described below with reference to FIGS. 1-4.

FIG. 1 illustrates a system 100 for presenting one or more images to viewers in order to allow the viewers to perceive an enhanced and/or a unique viewing experience. More particularly, the system 100 may include a user 102, a presentation device 104, a network 106, and one or more content server(s) 108. In various embodiments, the presentation device 104 may include one or more processor(s) 110, memory 112, an images component 114, and a display component 116. Moreover, the content server 108 may include one or more processor(s) 118 and a memory 120, which may include a feedback module 122, a modification module 124, and a visual effects module 126.

In various embodiments, the user 102 may utilize the presentation device 104 to view one or more images and/or videos. For the purposes of this discussion, the terms “images” and “videos” may be used interchangeably and one, both, or a combination of the two may be presented to the user 102. Moreover, in addition to presenting images to the user 102, the presentation device 104 may also present an image to each of the user's 102 eyes, whereby the presented images may be the same or different. In various embodiments, once the images are presented to the user 102, the user 102 may perceive a certain visual effect and possibly provide feedback regarding what was perceived by the user 102. For example the user 102 may provide a description of what was perceived by both eyes and/or what was perceived by each eye individually. In various embodiments, this feedback may be requested by, and/or provided directly to, the content server 108.

In alternate embodiments, the feedback submitted by the user 102 may then be transmitted to the content server 108. In various embodiments, the content server 108 may analyze the feedback in order to determine what was perceived by the user 102. More particularly, based at least in part on the specific images that were presented to the user 102, the content server 108 may determine how the combination of the two images were viewed and/or perceived by the user 102. If the visual effect that was perceived by the user 102 was the intended visual effect, the server device 108 may subsequently present this combination of images to users 102 in order to provide that certain visual experience to users 102.

In other embodiments, the images that were previously presented to the user 102 may be modified or different images may be presented to the user 102. Alternatively, the two images that were presented to the user 102 may be swapped such that a different one of the two images is presented to each eye of the user 102. Subsequently, once the images are presented to the user 102 via the presentation device 104, additional user feedback may be obtained. Similar to the process described above, the feedback may be provided directly to the content server 108 or may be otherwise communicated to the content server 108, which may deduce what was actually perceived by the user 102. The content server 108 may then determine the visual experience of the user 102 as a result of presenting those particular images. In addition, the content server 108 and/or the presentation device 104 may present one or more images to users 102 in order to enable the users 102 to perceive an enhanced and/or a unique visual experience.

In certain embodiments, the user 102 may be any individual that is able to view one or more images and/or videos provided by the presentation device 104. Moreover, for the purposes of this discussion, the presentation device 104 may be any type of device that can be used to present images and/or videos to one or more users 102. More particularly, the presentation device 104 may be any type of device that is configured to present the same image or two different images to each eye of one or more users 102. For instance, the presentation device 104 may provide a first image to the user's 102 right eye and a second, different image to the user's 102 left eye. Therefore, the user 102 may perceive a particular visual effect based at least in part on the images that are being presented to the user 102.

As set forth below in additional detail, the presentation device 104 may be any type of existing or future computing device that may present images to the user 102. In some embodiments, the presentation device 104 may be a binocular display device, such as a head-mounted display (HMD) device, that allows the user 102 to view and/or perceive the images. For example, the presentation device 104 may have a display optic in front of each eye (binocular HMD). In various embodiments, the HMD may have two (binocular) displays with lenses and semi-transparent mirrors embedded in a helmet, eye-glasses (also referred to as data glasses), or a visor. HMDs also may display a computer generated image (e.g., a virtual image), live images from the real world, or a combination of both. Furthermore, HMDs are able to display the same or a different image to each eye. When utilizing an HMD, the user 102 may perceive a visual effect that is being viewed by both eyes or a visual effect that is being viewed by one of the eyes.

As shown in FIG. 1, the presentation device 104 may include one or more processor(s) 110, memory 112, the images component 114, and the display component 116. The techniques and/or processes described herein may be implemented by multiple instances of the presentation device 104 and/or the content server 108, as well as by any other computing device, system, and/or environment. The presentation device 104, the network 106, and the content server 108 shown in FIG. 1 are only examples of a presentation device, a network, and a content server, respectively, and are not intended to suggest any limitation as to the scope of use or functionality of any presentation device, network, and/or content server that is utilized to perform the processes and/or procedures described herein.

With respect to the presentation device 104, the processor(s) 110 may execute one or more modules and/or processes to cause the presentation device 104 to perform a variety of functions. In some embodiments, the processor(s) 110 may be a central processing unit (CPU), a graphics processing unit (GPU), both CPU and GPU, or other processing units or components known in the art. Additionally, each of the processor(s) 110 may possess its own local memory, which also may store program modules, program data, and/or one or more operating systems. The presentation device 104 may also possess some type of component, such as a communication interface, that may allow the presentation device 104 to communicate and/or interface with the user 102, the network 106 and/or one or more devices, such as the content server 108.

Depending on the exact configuration and type of the presentation device 104, the memory 112 may be volatile (such as RAM), non-volatile (such as ROM, flash memory, miniature hard drive, memory card, or the like) or some combination thereof. The memory 112 may include an operating system, one or more program modules, and program data. In additional embodiments, the presentation device 104 may have additional features and/or functionalities. For example, the presentation device 104 may also include additional data storage devices (removable and/or non-removable) such as, for example, magnetic disks, optical disks, or tape. Such additional storage may include removable storage and/or non-removable storage.

The presentation device 104 may also have input device(s) such as a keyboard, a mouse, a pen, a voice input device, a touch input device, one or more buttons, etc. Output device(s), such as the display component 116, a light-emitting component, speakers, a display to present images, etc. may also be included. In some embodiments, the user 102 may utilize the foregoing features to view a different image that is presented to each eye of the user 102. For example, the presentation device 104 (e.g., a binocular HMD device) may present a first image to one eye of the user 102 and a second, different image to the user's 102 other eye. As a result, the user 102 may perceive a certain visual effect and/or viewing experience based at least in part on the particular images that are presented to the user 102. The user 102 may then use the input device(s) to submit feedback relating to what was perceived by the user 102.

In various embodiments, the images component 114 of the presentation device 104 may determine which images will be presented to the user 102. More particularly, the images component 114 may present a first image to one eye of the user 102 and also present a second, different image to the other eye of the user 102. Additionally, the images component 114 may also change which images are presented to the user 102 and/or modify the images such that user 102 will be presented with slightly different images than what were previously presented. That is, the images component 114 may modify any parameter of an image (e.g., color, hue, sharpness, contrast, etc.) so that different images will be presented to each eye. For example, provided that the same image was being presented to each eye, the images component 114 may modify a parameter associated with one of the images to determine how the new combination of images will be perceived. Similarly, if two different images are currently being presented to the user 102, the images component 114 may modify at least one of the images in order to determine whether such a change has an effect on the user's 102 perception of the two images.

Furthermore, the display component 116 of the presentation device 104 may present the images to the user 102. The images may be displayed to the user 102 via a display screen, an HMD, and/or any other manner of presenting images to the user 102. The display component 116 may also identify any differences between the images being presented to each eye and may allow for the user 102 to submit feedback regarding what he/she perceived. This feedback may be provided directly to the content server 108, manually entered into the content server 108, and/or otherwise communicated to the content server 108 via the network 106.

It is appreciated that the illustrated presentation device 104 is only one example of a suitable device and is not intended to suggest any limitation as to the scope of use or functionality of the various embodiments described. Other well-known computing devices, systems, environments and/or configurations that may be suitable for use with the embodiments include, but are not limited to any mobile and/or wireless devices, personal computers, hand-held or laptop devices, multiprocessor systems, microprocessor-based systems, set top boxes, game consoles, programmable consumer electronics, network PCs, minicomputers, and/or distributed computing environments that include any of the above systems or devices. In addition, any or all of the above devices may be implemented at least in part by implementations using field programmable gate arrays (“FPGAs”) and application specific integrated circuits (“ASICs”), and/or the like.

In other embodiments, and as stated above, the content server 108 may be any type of device that is configured to select a combination of images to be presented to the user 102 in order to provide an enhanced and/or unique visual experience to the user 102. More particularly, the content server 108 may identify two different images that, when presented to each eye of the user 102, cause the user 102 to perceive a certain visual effect. Moreover, the content server 108 may receive feedback from users 102 that describe what was actually perceived and possibly make modifications and/or adjustments as to which images should be presented to users 102. As mentioned previously, the content server 108 may include one or more processor(s) 118 and a memory 120, which may include the feedback module 122, the modification module 124, and the visual effects module 126. In various embodiments, the processor(s) 118 and the memory 120 of the content server 108 may be similar to, or different from, the processor(s) 110 and the memory 112, respectively, of the presentation device 104. Moreover, the content server 108 may be any type of computing device or server device, such as the presentation device 104 described above. That is, the content server 108 may provide the images to the user 102 in order to cause the user 102 to perceive a certain visual effect.

The feedback module 122 may receive feedback from users 102 who were presented the images via the presentation device 104. For example, in order to provide a certain perceived visual experience to the user 102, the content server 108 may initially select which images are to be presented to the user 102. For example, the content server 108 may select two different images that, when viewed by each eye of the user 102, may cause the user 102 to perceive a certain visual effect. In response to presenting those images, the feedback module 122 may receive feedback relating to what the user 102 actually perceived. In addition, the feedback module 122 may determine whether the visual effect that was perceived by the user 102 was the visual effect that was initially intended.

In other embodiments, the modification module 124 of the content server 108 may modify and/or replace the images that are to be presented to the user 102 via the presentation device 104. For example, provided that a first and a second image are being presented to each eye of the user 102, and regardless of whether the first and second images are the same or different from one another, the modification module 124 may modify at least one of the images in order to cause the user 102 to perceive a certain (e.g., different) visual effect. Alternatively, the modification module 124 may change which images are to be presented to the user 102 in order to produce a different perceived visual effect. Moreover, the two images presented to the user 102 may be swapped such that a different one of the two images is presented to each eye of the user 102. Therefore, the modification module 124 may facilitate in selecting which images will be presented to the user 102, and based at least in part on those images, a particular visual experience that will be perceived by the user 102.

The visual effects module 126 may determine an intended visual effect that the user 102 should perceive. In order to do so, the visual effects module 126 may assist in selecting which combination of images will achieve that visual effect. Therefore, other than, or in addition to, providing a three-dimensional visual effect to the user 102, the visual effects module 126 may cause the user 102 to perceive an enhanced and/or a unique visual experience based at least in part on the images that are presented to each eye of the user 102.

The visual experience and/or visual effect that are perceived by the user 102 may also be affected by the eye dominance (e.g., ocular dominance, eyedness, etc.) of the user 102. For the purpose of this discussion, eye dominance may refer to the tendency of some users 102 to prefer, either consciously or subconsciously, visual input from one eye to the other. Therefore, how certain images are perceived by a particular user 102 may depend upon whether that user 102 is eye dominant, and if so, whether the user 102 is left-eye dominant or right-eye dominant. Moreover, since some individuals may be more eye-dominant than others, the perception of the user 102 may also depend on the extent to which that user 102 is eye dominant. That is, the image that is presented to the dominant eye may be perceived more so than the image that is directed towards the non-dominant eye, thus causing eye-dominant users 102 to perceive a visual effect differently from non-eye dominant users 102 or from users 102 with different eye dominance.

With respect to the presentation device 104 and/or the content server 108, computer-readable media may include, at least, two types of computer-readable media, namely computer storage media and communication media. Computer storage media may include volatile and non-volatile, removable, and non-removable media implemented in any method or technology for storage of information, such as computer readable instructions, data structures, program modules, or other data. The memory 112 and 120, the removable storage and the non-removable storage are all examples of computer storage media. Computer storage media includes, but is not limited to, random-access memory (RAM), read-only memory (ROM), electrically erasable programmable read-only memory (EEPROM), flash memory or other memory technology, compact disc read-only memory (CD-ROM), digital versatile disks (DVD), or other optical storage, magnetic cassettes, magnetic tape, magnetic disk storage or other magnetic storage devices, or any other non-transmission medium that can be used to store the desired information and which can be accessed by the presentation device 104 and/or the content server 108. Any such computer storage media may be part of the presentation device 104 and/or the content server 108. Moreover, the computer-readable media may include computer-executable instructions that, when executed by the processor(s) 110 and 118, perform various functions and/or operations described herein.

In contrast, communication media may embody computer-readable instructions, data structures, program modules, or other data in a modulated data signal, such as a carrier wave, or other transmission mechanism. As defined herein, computer storage media does not include communication media. In various embodiments, memory 112 and 120 may be examples of computer-readable media.

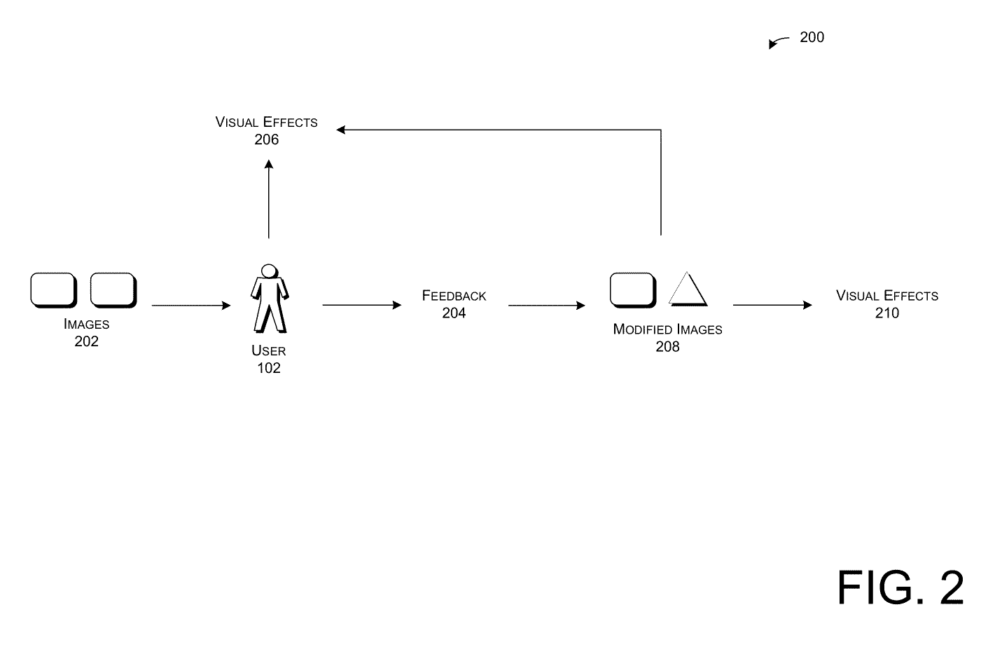

FIG. 2 illustrates a system 200 for presenting different images to a user in order to generate a perceived visual effect. In various embodiments, a different image may be presented to each eye of the user, which may cause the user to experience a unique and/or an enhanced visual experience. In various embodiments, the visual effect perceived by the user may be a visual effect other than, or in addition to, a perceived three-dimensional (3D) visual effect.

In some embodiments, two different images 202 may be presented to a user 102. The images 202 may be presented to the user 102 utilizing the presentation device 104 and/or the content server 108, as illustrated in FIG. 1. The images 202 may be a set of image 202 pairs that differ in some respect, such as by differing with respect to content, color, brightness, hue, contrast, sharpness, or any other manner in which images 202 or videos may differ. In various embodiments, each image 202 pair may be presented to the user 102 any number of times and for any duration of time. Furthermore, the images 202 that are presented to each eye of the user 102 may be swapped such that each eye then views the other image 202 of the image 202 pair.

Upon viewing the images 202 via the presentation device 104 and/or the content server 108, the user 102 may experience certain visual effects 206. For instance, the combination of images 202 that are viewed through each of the user's 102 eyes may cause the user 102 to perceive a visual effect 206 that is different from each of the images 202. For instance, assume that a certain component of the first image 202 was a first color (e.g., blue) and that the same component included in the second image 202 was a second, different color (e.g., red). As a result of the user 102 viewing this component of the images 202, and in particular, viewing a different color of the component in each of the images 202, the user 102 may perceive that the component with a color sensation different from the first color and the second color. Therefore, by presenting two different images 202 to the user 102, the visual effect 206 that is perceived by the user 102 may be different from each of the two images 202.

Alternatively, or in addition to the foregoing, the user 102 may also submit feedback 204 during or after the images 202 are presented to the user 102. The feedback 204 may relate to the user's 102 perception of the images 202, such as a description of what the user 102 did, or did not, see. In various embodiments, the user 102 may be asked to describe in their own words what he/she perceived in as much detail as possible. The user 102 may also volunteer information relating to what the user 102 was perceiving while the images 202 were being presented to the user 102. If the user 102 is not able to discover the visual effects 206 that were intended, the user 102 may be provided one or more hints that suggest the particular region of the images 202 that includes the visual effects 206. In various embodiments, the hints may suggest an area of the images 202 that include the visual effects 206 without actually suggesting the particular visual effect 206 that the user 102 is expected to perceive.

Provided that the user 102 has submitted feedback 204 relating to the images 202, the content server 108 may modify the images 202 (e.g., modified images 208). For instance, if the user 102 indicated that what was perceived by the user 102 was not the intended visual effect 206, the images 202 may be modified in order to achieve that visual effect 206. For instance, and as shown in FIG. 2, the two images 202 are represented as two rectangles. The images 202 may then be modified such that the modified images 208 include a rectangle and a triangle. When the modified images 208 are presented to the user 102, the user 102 may perceive the visual effects 206 that were initially intended or different visual effects 210. The visual effects 210 may also be perceived if the modified images 208 include two images 202 that are different from the previously presented images 202. Therefore, the user 102 may experience a unique and/or enhanced visual experience (e.g., visual effects 206, visual effects 210, etc.) based at least in part on the particular images 202 (e.g., images 202, modified images 208, etc.) that are presented to each eye of the user 102.

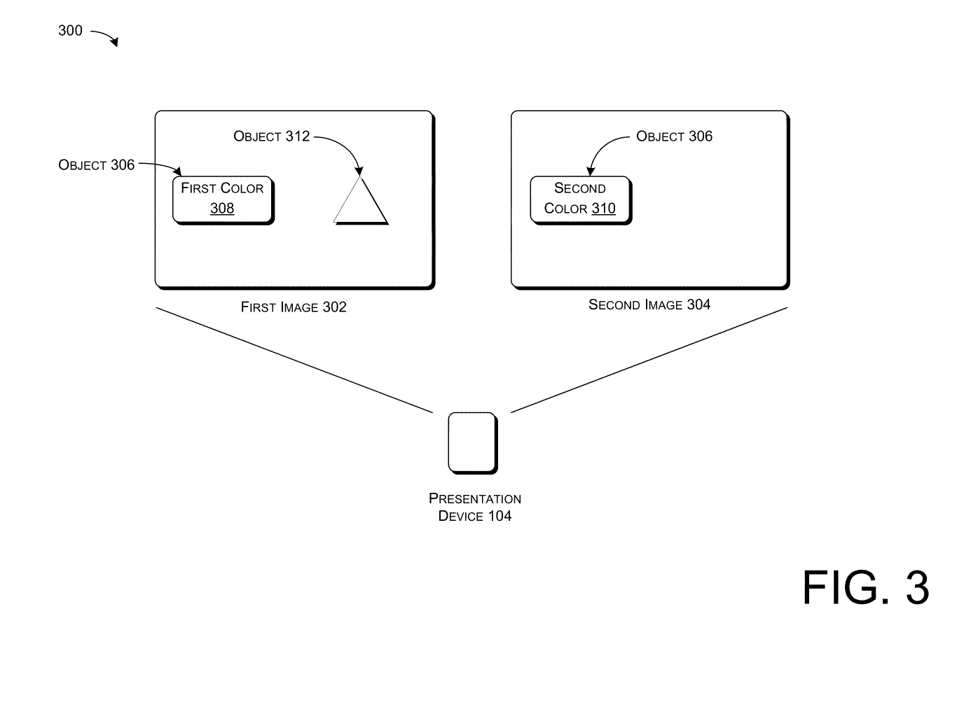

FIG. 3 illustrates an example system 300 for presenting two images to a user via a presentation device. More particularly, the presentation device 104, which may also be the content server 108, may present a first image 302 and a second image 304 to the user 102. In various embodiments, the first image 302 and the second image 304 may differ in any manner, such as by differing with respect to content, color, sharpness, brightness, hue, contrast, and/or any other manner that may differentiate the first image 302 and the second image 304. Furthermore, the presentation device 104 may present the first image 302 to one eye of the user 102 and the second image 304 to the other eye of the user 102. As a result, the user 102 may view a different image through each eye, which may allow the user 102 to perceive a visual effect that is different from either the first image 302 and/or the second image 304. That is, the visual effect perceived by the user 102 may be different from what would be perceived if the user 102 were viewing only one of the images (e.g., the first image 302, the second image 304, etc.).

As shown, the first image 302 may include object 306 and object 312 and the second image may also include object 306. Each of the objects may be any component or content included within the first image 302 and the second image 304. For example, the objects (e.g., object 306, object 312, etc.) may be animate or inanimate objects and may differ in any manner. Further, object 306 that is included within the first image 302 and the second image 304 may be the same object, but may differ in some way. As an illustrative example, object 306 may be depicted as a first color 308 in the first image 302 and then may be depicted as a second color 310 in the second image 304. In these embodiments, the first color 308 and the second color 310 may be different colors. As a result of the object 306 being associated with two different colors in the first image 302 and the second image 304, the user 102 may perceive the object 306 to be associated with a color sensation that is different from the first color 308 and the second color 310. For instance, the color of the object 306 that is perceived by the user 102 may be a spatial or temporal mix of the first color 308 and the second color 310, or a more complex sensation such as perceived shininess. Therefore, by presenting two different images to the user 102, the user 102 may perceive different, unique, and/or enhanced visual effects.

In other embodiments, the first image 302 may include object 312, whereas the second image 304 may not include an object that corresponds to object 312. By having an object in one image but not the other, the user 102 may perceive certain visual effects associated with this object (e.g., object 312). For example, the user 102 may perceive object 312 when opening the eye that is directed to the first image 302 and closing the eye that is associated with the second image 304. Similarly, the user 102 may not perceive object 312 when he/she closes the eye associated with the first image 302 and opens the eye that is being presented with the second image 304. In additional embodiments, the user 102 may experience a different visual effect when the user 102 views the first image 302 and the second image 304 with both eyes open. For instance, the user 102 may perceive the object 312 as it appears in the first image 302 or the user 102 may not perceive the object 312 at all. The user 102 may also perceive a ghosting or flickering effect of the object 312, meaning that the object 312 may continuously appear and then disappear or that the object 312 may appear lighter or less vivid as compared to other objects.

Accordingly, based at least in part on two different images that are presented to each eye of the user 102, the systems and/or processes described herein may cause the user 102 to perceive certain visual effects that would not be perceived if the user 102 was viewing one of the images in isolation. Therefore, the way in which users 102 perceive certain images may be altered or enhanced in an intended manner. As set forth below, many different visual effects may be achieved by exposing users 102 to specific computer-generated images. For instance, producing differences between a pair of images (e.g., first image 302 and second image 304), such as differences in color, sharpness, content, etc., may yield certain visual effects that include highlighting, compositing, hiding, and wowing.

In various embodiments, highlighting may seek to make certain regions of interest (e.g., objects) more noticeable to the user 102, such as by displaying different colors to the two eyes in that particular region of the image. For example, and as described above, object 306 may be the region of interest with respect to the first image 302 and the second image 304 that are presented to the user 102. Here, the first color 308 of the object 306 in the first image 302 may be different from the second color 310 of the object 306 that is included within the second image 304. In various embodiments, a certain visual effect may be produced by coloring the region (e.g., object 306) using two contrasting colors. For instance, the first color 308 and the second color 310 may have a varying hue difference, saturation difference, and brightness difference. Furthermore, assume that the object 306 included in the first image 302 and the second image 304 differs between violet (e.g., first color 308) in the first image 302 and green (e.g., second color 310) in the second image 304. As a result, the user 102 may perceive that the object 306 is highlighted and/or that the object 306 has a color sensation different than violet and green. For example, the color sensations that are perceived may be unnatural colors that lie between complementary colors, such as “yellowish-blue.”

Regions (e.g., object 306) of highly saturated color pairs that differ in hue may be particularly prominent to users 102. In some embodiments, these regions may only be particularly prominent if the region is above a certain threshold, such as thresholds relating to size or view angle. Provided that the images with differing colors were presented to each eye of a user 102, the regions of varying color may be perceived as being highlighted and/or blinking. This particular region (e.g., object 306) may also appear as being fluorescent, bright, emitting light, and/or floating outside the perceived image plane.

Eye dominance may also be a noticeable factor when considering what visual effect(s) will be perceived by users 102. That is, a particular user 102 who is eye-dominant in one eye may perceive the color being presented to the dominant eye. Moreover, that user 102 may perceive a different color sensation that is more similar to the color being presented to the dominant eye than the color that is associated with the non-dominant eye. In some embodiments, and assuming that the user 102 is eye-dominant, different sensations or visual effects may be perceived when the first image 302 and the second image 304 are inverted. On the other hand, these sensations or visual effects may not be stable, which may be a typical quality of binocular rivalry.

Accordingly, presenting two different images (e.g., first image 302, second image 304) that each have a region that differs in some manner (e.g., color, contrast, hue, brightness, sharpness, etc.) to each eye of the user 102 may cause the user 102 to perceive that particular region as being highlighted. Moreover, the regions (e.g., object 306) having different colors need not be prominent from their surroundings within the image in order to achieve the highlighting visual effects perceived by users 102. Therefore, these visual effects may be achieved without disturbing the composition of the individual image.

In other embodiments, a compositing effect may be achieved by presenting two images (e.g., first image 302, second image 304) of the same scene that are complementary or overlapping in terms of an information spectrum along a certain dimension. As a result of presenting these images to the user 102, the human perception system may be able to composite such information in order to receive a higher bandwidth than what is possible with a single view of the scene. In various embodiments, the compositing visual effect may be implemented with respect to a dynamic range and/or pseudo colors.

Compositing with respect to a dynamic range may refer to presenting a pair of images or photographs that are taken at different exposures, with each image or photograph of the pair missing part of the illumination range of the original physical environment. When shown image pairs with different exposures, users 102 may perceive details that available in either of the images, where the corresponding region in the counterpart image is subject to overexposure of underexposure due to a limited dynamic range of the capture device (e.g., camera, etc.) that took the photograph or image. This may be explained by contour dominance, where the rich contours in one of the images may effectively suppress the nearly uniform white/black regions (due to overexposure or underexposure) in the other image.

Comparatively, if the above two images are averaged into a single image, such an average image may also incorporate the foregoing features, but those features may be perceived to be less prominent since averaging the images may reduce the overall contrast of the images. In some embodiments, and depending upon whether the user 102 is eye-dominant, swapping which image is presented to each eye may also result in a perceived change of global brightness of the image and/or a perceived change in the light source (e.g., position, direction, color, etc.) associated with the image. Moreover, the change in global brightness and/or the change in the light source may be biased towards the dominant eye, if the user 102 is determined to be eye-dominant.

In addition to compositing a dynamic range, pseudo colors may be composited to create a certain visual effect. For the purposes of this discussion, pseudo color images may refer to images having pixel values that do not represent true visible light intensities, but instead represent some other physical channels such as temperature or near infrared (IR) response. By allowing the user 102 to composite a normal red-green-blue (RGB) images with such a pseudo color image, or two different pseudo color images, the user 102 may be able to appreciate the complementary nature of different channels. The RGB color model may refer to an additive color model in which red, green, and blue light is added together in various manners in order to produce a broad array of colors.

As an example of compositing pseudo colors with respect to temperature, the two images presented to users 102 may include an RGB image (e.g., first image 302) and an temperature map image (second image 304), which may display colors based at least in part on the respective temperatures associated with the image when the image was taken. For instance, the image may depict the same scene in which one or more individuals are in an outside environment. The RGB image may depict the actual RGB colors of the scene, as perceivable by human viewers, whereas the temperature map image may illustrate colors based on the temperature of the individuals and/or other objects included in the image (e.g., trees, grass, etc.) with respect to the surroundings (e.g., the air). That is, provided that higher temperatures are associated with brighter colors, and since the individuals themselves may be warmer than the surrounding air, the individuals may be depicted as being a brighter color.

In the above embodiments, for the RGB-temperature image pair, users 102 may perceive bright human figures (e.g., the individuals) but it may be difficult to perceive the human figures' actual color. However, users 102 may be able to perceive the color of the background grassland and may identify it as being the color green. Comparatively, if the RGB image and the temperature image are averaged into a single image, users 102 may perceive that additional colors could be observed on the human figure, but that the background color may be less obvious.

Moreover, for the RGB-IR image pairs, the boundaries of different objects (e.g., plants, brightly colored blankets, signs, etc) may be perceived as being bright and often floating within the image. However, if the RGB image and the IR image are averaged to form a single image, the color associated with the image may not appear as vivid and the brightness or the floating nature associated with the boundaries between objects may disappear or be diminished. Moreover, the effect of eye dominance of the user 102 may be primarily on the overall perceived saturation of the image. That is, when the gray scale IR image is shown to the dominant eye of the user 102, a reduced amount of saturation may be perceived as compared to viewing the IR image with the non-dominant eye of the user 102.

Accordingly, in the RGB-temperature image pair, the textured background of the RGB image, which may be represented by the color of the grass, the color of the sky, etc., may suppress the almost uniform background of the temperature map image. For instance, in the temperature map image, the background of the scene may be somewhat dark as compared to the human figure since the temperature of the objects included in the surroundings may be similar. Moreover, the edges of the human figure in the temperature map image may suppress the perception of the normal color of the human figure. In the RGB-IR image pair, the relatively large luminance difference of the objects between the RGB and the IR images may be easily perceived by users 102. This effect may be exploited in vegetation inspection applications, by feeding RGB video and IR video to each eye, while letting the human brain perceive the distracting areas as the possible contours of vegetation.

As a result, humans are able to effectively incorporate multi-spectrum visual information through binocular vision and perceive certain visual effects when a combination of images is presented to users 102. Moreover, by presenting pseudo color images in combination with RGB color images, certain visual effects may be perceived by users 102.

In additional embodiments, the concept of hiding may refer to presenting information that is only visible when viewing an image with one eye, but is invisible or barely noticeable, at least for some period of time, when viewing the image with both eyes. That is, this hiding effect may turn visible information in monocular images, such as objects 306 and/or 312, invisible or barely noticeable in binocular vision. Therefore, information may be hidden from the viewer when both eyes are open, while also allowing that information to become visible with the user 102 closing one of the eyes. In various embodiments, hiding may provide a mechanism for switching between information layers. For example, when users 102 play video games, the users 102 typically keep both eyes open in order to view the regular game view. However, the user 102 may occasionally close one eye to access additional information, such as game or player statistics. This may be performed without needing to actively sense the eye movement of the user 102.

In various embodiments, examples of hiding may include hiding using color dot patterns and/or hiding by blurring. When the human brain attempts to fuse different colors presented to two eyes into one, the visual effects perceived by the user 102 may range from a stable uniform fused color to a color sensation that varies both in space and in time. Regardless of the perceived color outcome, it may be difficult for the user 102 to separate the two colors and determine which eye is seeing which color. Therefore, by rendering a shape in one eye using a foreground and a background color, and by rendering the same shape in the other eye but with the foreground and background colors reversed, the user 102 may perceive a consistent fusion of the colors, or any other possible outcomes from viewing these two different colors in each of the two eyes, regardless of which color comes from which eye. Accordingly, information included in each individual image may become invisible to the user 102 when viewed with both eyes.

Furthermore, if a visual contour exists between the colors in either image, such contours may be perceived individually by each eye. As a result, the contours may not be eliminated by binocular vision. In order to eliminate the contours, the shape may be converted into a dot grid pattern so that the shape is encoded in the color contrast only. The image pair having the dot grid pattern may include varying levels of grid resolution and/or multiple different color schemes, such as utilizing complementary colors or similar colors. The user 102 may be better able to identify the correct dot grid pattern in higher resolution image pairs and it may be more difficult to determine the pattern in lower resolution image pairs. Moreover, even if the user 102 is able to identify the correct pattern in higher and lower resolution image pairs, the correct pattern may be identified in higher resolution image pairs more quickly.

In additional embodiments, in order to hide information by utilizing contour dominance and human sensitivity to different spatial frequencies (e.g., hiding by blurring), image pairs may be created that illustrate different semantic information in corresponding regions, while having different levels of sharpness. Contour dominance may result in sharp information (e.g., present only in one of the images and therefore only perceived by one eye) masking the blurred information (e.g., present only in the other image and therefore only perceived by the other eye) when both eyes are open, while the blurred information may become visible when one of the eyes is closed. This principle may be applied to multiple regions of the image pair, so that each image contains regions that can be either masking the other image or masked by the other image. As a result, three individual views may be perceived and/or revealed when the user 102 closes either one of the eyes, or opens both eyes.

Upon presenting an image pair to a user 102, in which a region in one image is sharper and a corresponding region in the other image is more blurred, the sharper image is most likely to be perceived by the user 102. In comparison, if the two regions/images are averaged into a single image, the user 102 may be unable to recognize either of the images. In various embodiments, the foregoing effects may be used to hide text or simple graphics to uninformed users 102, while the hidden text or graphics is recognizable by informed users 102.

In further embodiments, the effect of wowing may refer to creating certain sensations that may facilitate compelling visual experiences in applications such as an entertainment setting (e.g., movies, etc.). More particularly, wowing may relate to creating visual effects such as “hyper-colors”, which may refer to color sensations that are not typically perceived by users 102. For instance, when two different colors are presented to different eyes of the user 102, the user 102 may perceive unexpected color sensations, such as inhomogeneous color patches that change smoothly over time, fluorescent light, jittering color patches, bright outlines of various regions within the image, shiny portions of the image, and/or other visual effects that are different from perceiving either color that was presented to the user 102.

In other embodiments, the wowing effects may include a ghosting effect, which may cause a particular portion of the image to appear ghost-like. In these embodiments, although two image pairs may be presented to a user 102, a particular object may be presented in the image that is directed to one eye, but not in the image that is projected to the other eye. The ghosting effect may cause the object to have varying degrees of transparency, as opposed to either perceiving or not perceiving the object.

With respect to allowing users 102 to perceive hyper-colors, as described above, the systems and/or processes described herein may create a binocular color space and/or one or more respective color models that define such hyper-colors. This color space and/or model may be utilized to create the visual effect of hyper-colors, such as by assigning values to each color such that certain hyper-colors may be created. That is, the hyper-color space and/or model may serve as a palette and/or a reference that may be used to create different hyper-colors. Existing color spaces and/or models, such as the RGB color model, may define inter-relations between different colors and may generate colors utilizing a combination of existing colors. In addition, the HSL (Hue Saturation Lightness) color model may allow for various colors to be created based on coordinates of existing colors that are representative of the hue, saturation, and lightness of those colors. However, in addition to creating the perception of certain hyper-colors, multiple hyper-colors may also be created utilizing the hyper-color space that is described herein.

The hyper-color space as described above may be created in various manners. In some embodiments, each hyper-color in the hyper-color space may represent a combination of two colors, one color that is presented to one eye and a different color that is presented to the other eye. Moreover, each color may have an RGB value, which may contain three different values (e.g., R, G, and B) that make up the color. Accordingly, since there are two different colors that are presented to each eye, and because each color may have three different values, there may be six different values that are associated with a single hyper-color (e.g., 2 colors presented to each eye×3 values per color=6 values). Three of the values may be perceived with one eye and three other three values may be perceived utilizing the other eye.

The foregoing hyper-color space may be created by receiving user feedback. For instance, users 102 may be asked to compare one hyper-color with two other hyper-colors and then provide feedback that indicates which of the two hyper-colors is more similar to the hyper-color in question. By comparing the user feedback with respect to one another, an algorithm, such as a comparison-based machine learning algorithm, may identify a space that accommodates and/or satisfies similarity criteria between the pair of colors. Then, the dimensionality of the color space may be tested and/or modified in order to determine the actual dimensions of the color space. Furthermore, the systems and processes described herein may also calculate the distance between the different coordinates within the color space. As a result, the hyper-color space may be defined and be perceptually uniform, meaning that the distance (e.g., Euclidian distance) between values and/or coordinates of the different hyper-colors in the color space may represent the similarity between different hyper-colors within the hyper-color space. More specifically, the similarity between the different hyper-colors may be based at least in part on the user's 102 perceived similarity of the hyper-colors.

By creating such a hyper-color space, a reference may be generated such that particular hyper-colors may be selected in order to achieve a certain visual effect. For instance, if a designer desires to provide a particular viewing experience to users 102, such as causing the users 102 to perceive a certain hyper-color, the designer may access the hyper-color color space and identify the specific hyper-colors that, when presented to users 102, actually cause the users 102 to perceive the intended visual effect. That is, an individual may use such a hyper-color space as a reference in order to determine which colors to use and/or combine in order to create a different perceived hyper-color. In addition, provided that a particular visual effect is being perceived by a user 102, the perceived visual effect may be modified or enhanced by adjusting a value in the hyper-color space that will adjust which hyper-color is perceive by the user 102 and, therefore, will allow that visual effect to be achieved.

In other embodiments, the eye dominance of users 102 may be considered when attempting to cause the users 102 to perceive a certain visual effect. That is, since different visual effects of an image may be affected by the eye dominance of a particular user 102, the visual effects that are to be perceived by the user 102 may be compensated based on whether that user 102 is eye-dominant and, if so, the extent of the user's 102 eye dominance. By knowing the eye dominance of users 102, the systems and/or processes described herein may cause users 102 to perceive the same visual effects regardless of whether those users 102 are eye-dominant or not. As stated above, a user 102 that is eye-dominant may perceive and/or view a majority of images from the eye that is dominant.

In order for eye dominance to be included as a factor in determining what users 102 will perceive, the extent of eye dominance should be identified. In various embodiments, the extent of eye dominance of users 102 may be measured by examining the users 102. Once eye dominance has been determined, the images that are presented to users 102 may be adjusted or modified, or some other compensation may be made so that the image(s) are perceived by the user 102 as intended. That is, the parameters associated with an image may be dynamically changed based at least in part on the eye dominance of the user 102, where the eye dominance may be determined based on user feedback. For example, provided that the user 102 is presented two images having different colors (e.g., red in one eye, green in the other eye), if the user 102 perceives one color more than the other color, the eye that perceives that color is most likely dominant Eye dominance may also be determined by measuring the duration in which the user 102 perceives both of the colors. If one of the colors is perceived longer than the other, the eye that perceives this color is mostly likely dominant. Although the color of images is mentioned in the above example, any parameter of the image (e.g., sharpness, hue, contrast, etc.) may be utilized to measure eye dominance.

Accordingly, if it is determined that a particular user 102 is eye-dominant, the parameters of the images presented to users 102 may be modified and/or adjusted in order to cause that user 102 to perceive the intended visual effect. For instance, with respect to the hiding by blurring techniques described above, a blurred image may be overridden so that a sharper image is perceived. More particularly, provided that a user 102 is right eye dominant, that a sharp image is presented to the left eye of a user 102, and that a blurred image is presented to the right eye, the blurred image may be perceived by that user 102, which may not be the intended visual effect. As a result, the image being presented to the right eye may be further blurred so that the sharp image may surpass the blurred image and be perceived by the user 102.

In various embodiments, the eye dominance of a user 102 may be determined before and/or after the user 102 is presented with the images. Moreover, an algorithm (e.g., a machine learning algorithm) may be utilized to relate what the user 102 observed (e.g., sharpness of the image) and a parameter associated with what the user 102 perceived (e.g., eye dominance of the user 102). Using such an algorithm, the relationship between the user's 102 perception of the image and the actual measured eye dominance of the user 102 may be extracted. In some embodiments, a model may be created that correlates the eye dominance to the amount of compensation needed to create the intended visual effect. For example, once the user's 102 eye dominance is known, the model may indicate the extent to which the image should be modified in order for the user 102 to perceive the desired visual effect, regardless of the eye dominance of that user 102. Moreover, in addition to eye dominance, any other characteristic associated with the user's 102 vision or the user's 102 perception of an image (e.g., eyesight, nearsightedness, farsightedness, etc.) may be considered utilizing the foregoing techniques.

The systems and/or processes described herein discuss presenting different static images to users 102 in order to cause the user 102 to perceive an enhanced and/or a unique visual effect. However, these principles may also be extended to videos or moving images, where motion included in the images may not match between the two eyes. For instance, motion may be utilized to create special effects, such as hiding. That is, if a static image is presented to one eye and an image that includes motion is presented to the other eye, the motion may override the static image and may cause the user 102 to perceive the image that includes the motion. In addition, if a user 102 perceives motion only within one image (e.g., a moving cursor), the objects surrounding the moving object in that image may override those in the other image without motion.

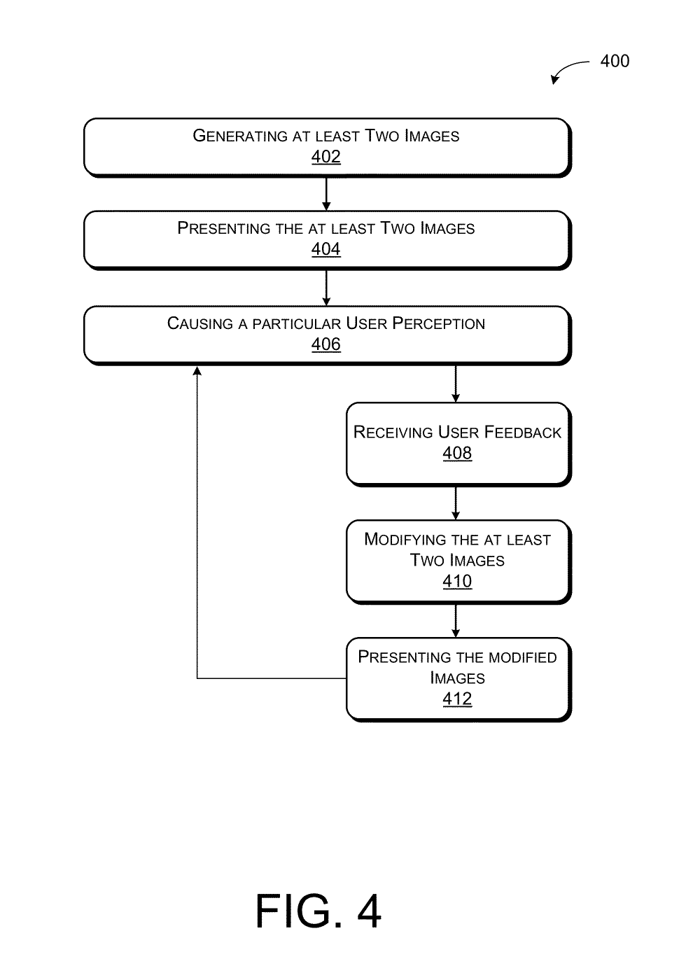

FIG. 4 illustrates an example process for causing a user to perceive a certain visual effect based on the particular images presented to the user. The example processes are described in the context of the systems of FIGS. 1-3, but are not limited to those environments. The order in which the operations are described in each example process is not intended to be construed as a limitation, and any number of the described blocks can be combined in any order and/or in parallel to implement each process. Moreover, the blocks in FIG. 4 may be operations that can be implemented in hardware, software, and a combination thereof. In the context of software, the blocks represent computer-executable instructions that, when executed by one or more processors, cause one or more processors to perform the recited operations. Generally, the computer-executable instructions may include routines, programs, objects, components, data structures, and the like that cause the particular functions to be performed or particular abstract data types to be implemented.

FIG. 4 is a flowchart illustrating a process 400 for presenting at least two different images to a user in order to cause the user to perceive a certain visual effect. In various embodiments, the operations illustrated in FIG. 4 may be performed by the presentation device 104 and/or the content server 108, as shown in FIGS. 1-3, or any other device.

In particular, block 402 illustrates generating at least two images. More particularly, two images may be selected that are to be presented to the user (e.g., user 102), where the images may be the same or different. In some embodiments, the images may illustrate the same scene but may differ in any manner, such as differing with respect to color, contrast, sharpness, brightness, hue, etc. For example, an object (e.g., person, tree, building, car, etc.) may be present in both images but the object may differ in color, size, sharpness, etc.

Block 404 illustrates presenting the at least two images. In various embodiments, the two images may be presented to a user utilizing any type of device (e.g., presentation device 104, content server 108, etc.), such as a computing device, a HMD device, etc. Furthermore, the images may be presented to the user such that one of the images is presented to the right eye of the user and the other image is presented to the left eye of the user. As a result, the user may view a slightly different image through each eye. The two images may be presented and/or modified in such a way in order to achieve a certain visual effect to be perceived by the user. For example, and as stated above, the visual effect that is intended may be a highlighting visual effect, a compositing visual effect, a hiding visual effect, a hyper-color visual effect, a ghosting visual effect, and/or any other type of visual effect that may cause the user to have a unique and/or enhanced viewing experience.

Block 406 illustrates causing a particular user perception. More particularly, in response to providing the two images to the user, and based at least in part on the differences between the two images, the user may perceive a particular visual effect, as set forth above. The visual effect may be the visual effect that was initially intended or a different visual effect. In addition, the visual effect perceived by the user may be different from the visual effect that is perceived when viewing each of the two images in isolation. For instance, if an object illustrated in both images is a different color in each image, the color sensation that is perceived by the user may be different from either of the colors that are included in the two images.

In some embodiments, the visual effect that is perceived by the user may be affected by the eye dominance of the user, or some other aspect associated with how a user perceives an image. Whether a user is eye-dominant and/or the extent of eye dominance may be measured and then taken into consideration when presenting the images to the user. As a result, if the eye dominance of the user is determined, the images may be altered such that users with no eye dominance and different degrees of eye dominance may perceive the same visual effect(s).

Block 408 illustrates receiving user feedback. In certain embodiments, after the images are presented, the user may provide feedback regarding what was actually perceived by that particular user. The feedback may be solicited from the user or may be volunteered by the user. That way, the systems and/or processes described herein may be able to determine what is actually being perceived by users when two different images are presented to those users.

Block 410 illustrates modifying the at least two images. In some cases, the visual effect that is perceived by a user may not be visual effect that was intended, which may be due to any reason (e.g., eye dominance, vision, etc.). As a result, the images that were presented to users may be modified in order to achieve the desired visual effect. In various embodiments, any aspect of the images may be modified and/or altered in order to cause the user to perceive the intended visual effect. Additionally, one or both of the previously presented images may be replaced with a different image, or the previously presented images may be inverted or swapped.

Block 412 illustrates presenting the modified images. In particular, after the images are modified, the modified images may be presented to each eye of the user. Since the images have been modified and/or adjusted, the visual effect(s) that the user perceives may have changed. Alternatively, the visual effect(s) experienced by the user may be the same visual effects that were previously perceived. In any event, upon viewing the images, the user may perceive a particular visual effect, as set forth in block 406.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A method comprising:
presenting at least two images to a user, a first of the at least two images being presented to a first eye of the user and a second of the at least two images that is different from the first image being presented to a second eye of the user;
receiving feedback relating to how the user perceived the first image and the second image;
modifying the first image or the second image based at least in part on the feedback; and
at least partly in response to the modifying, again presenting the first image and the second image to the user in order to cause the user to perceive an intended visual effect.

2. The method as recited in claim 1, further comprising:
determining an eye-dominance associated with the first eye or the second eye; and
if it is determined that the eye-dominance is present, modifying the first image or the second image to compensate for the eye-dominance.

3. The method as recited in claim 1, wherein the feedback describes a visual effect that was perceived by the user.

4. The method as recited in claim 1, wherein the intended visual effect is a visual effect other than, or in addition to, generating a three-dimensional visual effect that is perceived by the user.

5. The method as recited in claim 1, further comprising:
inverting the first image and the second image;
presenting different images to the user; or
associating the first image and the second image with a different eye of the user.

6. The method as recited in claim 1, wherein the intended visual effect is highlighting an object that is included in both the first image and the second image.

7. The method as recited in claim 1, wherein:
the first image and the second image depict a same scene and are complementary with respect to an information spectrum along a particular dimension; and
the intended visual effect enables the user to composite the first image and the second image in order to perceive a higher bandwidth than what would be perceived when viewing the first image or the second image in isolation.

8. The method as recited in claim 1, wherein the intended visual effect is at least one of:
presenting an object that is visible to the user when utilizing one of the first eye or the second eye but that is invisible or is less noticeable when the user utilizes both eyes; or
presenting the object in the first image but not in the second image.

9. The method as recited in claim 1, wherein the intended visual effect is a hyper-color that is generated by causing an object in the first image to be a different color from the object in the second image.

10. The method as recited in claim 9, wherein the hyper-color is generated by creating a hyper-color space that defines dimensions or values associated with a plurality of hyper-colors.

11. One or more computer-readable storage media having computer-executable instructions that, when executed by one or more processors, cause the one or more processors to perform operations comprising:
modifying at least one of two images such that a first image differs from a second image; and
presenting the first image and the second image via a display device to cause a perception of a particular visual effect, the particular visual effect being a visual effect other than, or in addition to, user perception of a three-dimensional visual effect.

12. The one or more computer-readable storage media as recited in claim 11, wherein the operations further comprise;
measuring an eye-dominance of a user that is to perceive the particular visual effect; and
modifying the first image or the second image based at least in part on the measured eye-dominance.

13. The one or more computer-readable storage media as recited in claim 11, wherein the first image is presented to a first eye of a user and the second image is presented to a second eye of the user.

14. The one or more computer-readable storage media as recited in claim 11, wherein the particular visual effect is associated with a combined image perceived by a user as a result of the user viewing the first image and the second image.

15. The one or more computer-readable storage media as recited in claim 11, wherein the particular visual effect includes at least one of a highlighting visual effect, a compositing visual effect, a hiding visual effect, a hyper-color visual effect, or a ghosting visual effect.

16. A system comprising:
one or more processors;
memory;
a modification module maintained in the memory and executable on the one or more processors to modify at least one of two images such that a first image and a second image differ from one another; and
a visual effects module maintained in the memory and executable on the one or more processors to present the first image and the second image such that when the first image and the second image are viewed, a particular visual effect other than, or in addition to, a three-dimensional visual effect is perceived.

17. The system as recited in claim 16, further comprising a feedback module maintained in the memory and executable on the one or more processors to receive feedback from at least one user that perceived the particular visual effect, the feedback describing the at least one user's perception of the particular visual effect.

18. The system as recited in claim 17, wherein:
the modification module further modifies the first image or the second image based at least in part on the feedback; or
the first image and the second image are derived from a single image.

19. The system as recited in claim 16, wherein at least the first image or the second image includes a series of images that illustrates a moving object.

20. The system as recited in claim 16, wherein:
the first image and the second image each include at least one object; and
the modification module modifies the at least one object in the first image or the at least one object the second image such that the at least one object in the first image differs from the at least one object in the second image.
